(19) United States
(12) Patent Application Publication
(10) Pub. No.: US 2010/0171994 A1
(43) Pub. Date: Jul. 8, 2010

(54) DOCUMENT READING APPARATUS

(75) Inventors: Loi Yew Kien, Singapore (SG); Kalmekolan Madan Mohan Reddy, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/648,507

(22) Filed: Dec. 29, 2009

(30) Foreign Application Priority Data
Jan. 6, 2009 (JP) 2009-000522

(51) Int. Cl. H04N 1/024

(52) U.S. Cl. 358/473

(57) ABSTRACT

A document reading apparatus includes a housing including a bottom surface formed with an opening for reading a document, and position detection sections disposed on the bottom surface as a pair while interposing the opening therebetween, thereby detecting a position of the document reading apparatus.

### BACKGROUND

1. Technical Field

The present invention relates to a document reading apparatus.

2. Related Art

According to the related art, hand scanning document reading apparatuses such as hand scanners or mouse scanners are disclosed in JP-A-11-345074. According to the document reading apparatuses, a position detection section detects a position of the document reading apparatus, so that image data of the entire document is generated from image data of the document which is fractionally obtained.

However, when an end of the document is read, the position detection section departs from the surface of the document, so that the position of the document reading apparatus may not be detected.

### SUMMARY

An advantage of some aspects of the invention is to detect the position of a document reading apparatus with high accuracy in a hand scanning document reading apparatus.

According to a first aspect of the invention, there is provided a document reading apparatus including: a housing including a bottom surface formed with an opening for reading a document; and position detection sections disposed on the bottom surface as a pair while interposing the opening therebetween, thereby detecting a position of the document reading apparatus.

In the document reading apparatuses according to the first aspect, the position detection sections are disposed on the bottom surface of the housing as a pair while interposing the document reading opening therebetween, so that the position of the document reading apparatus can be detected with high accuracy.

In the document reading apparatuses according to the first aspect, the bottom surface may have a pair of long sides and a pair of short sides connecting both ends of each long side, and the position detection sections may be disposed between the opening and the short sides. In such a case, the position detection sections are respectively disposed between the opening and the short sides, so that the position of the document reading apparatus can be detected with high accuracy.

In the document reading apparatuses according to the first aspect, a distance in a short side direction of the bottom surface from the long side to the position detection section may be longer than a distance in the short side direction from the long side to the opening. In such a case, the position detection sections are remote from the long side as compared with the opening, so that the position of the document reading apparatus can be detected with high accuracy.

In the document reading apparatuses according to the first aspect, the two position detection sections disposed between the opening and the short side may be spaced apart from the long side by the same distance in a short side direction, respectively. In such a case, the two position detection sections are respectively spaced apart from the long side by the same distance, so that the position of the document reading apparatus can be detected with high accuracy.

In the document reading apparatuses according to the first aspect, the opening may have a rectangular shape, and the two position detection sections may be disposed along end sides of the opening, respectively. In such a case, the two position detection sections are disposed along the end sides of the opening, so that the position of the document reading apparatus can be detected with high accuracy.

In the document reading apparatuses according to the first aspect, the position detection sections may detect the movement amount in the direction rotated by 45° with respect to a long side direction of the bottom surface. In such a case, since the position detection sections take a stance rotated by 45° with respect to a long side direction of the bottom surface, the document reading apparatus can read the document with high efficiency.

The invention can be realized in various types. For example, the invention can be realized as a copy machine, a facsimile machine or the like, which is provided at a part thereof with a hand scanner, in addition to the hand scanner and the mouse scanner.

### BRIEF DESCRIPTION OF THE DRAWINGS

The invention will be described with reference to the accompanying drawings, wherein like numbers reference like elements.

FIG. 1 is an exemplary view showing an external appearance of an upper side of a mouse scanner according to a first embodiment of the invention.

FIG. 2 is an exemplary view showing an external appearance of a lower side of a mouse scanner according to a first embodiment of the invention.

FIG. 3 is a view showing an arrangement configuration of a bottom portion of a mouse scanner.

FIGS. 4A and 4B are exemplary views showing sectional shapes of foot sections.

FIGS. 5A and 5B are views showing an arrangement configuration of a position detection module in a mouse scanner.

FIGS. 6A and 6B are views showing a state in which a document is read by a mouse scanner.

FIGS. 7A and 7B are exemplary views showing a state of the vicinity of a foot section when a document is read.

FIG. 8 is an exemplary view showing an external appearance of an upper side of a mouse scanner according to a modification.

FIG. 9 is a view showing an arrangement configuration of a lower portion of a mouse scanner according to a modification.

### DESCRIPTION OF EXEMPLARY EMBODIMENTS

Hereinafter, a document reading apparatus embodied as a mouse scanner according to an embodiment of the invention will be described with reference to the accompanying drawings.

### A. First Embodiment

### A1. External Configuration of Mouse Scanner

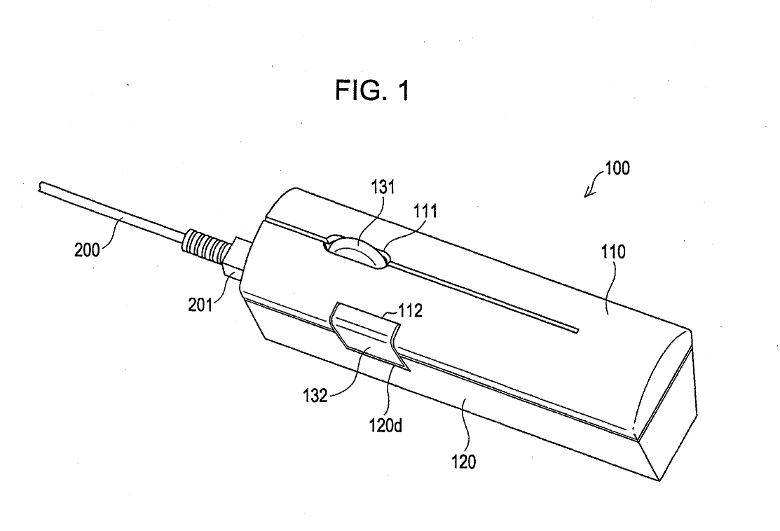

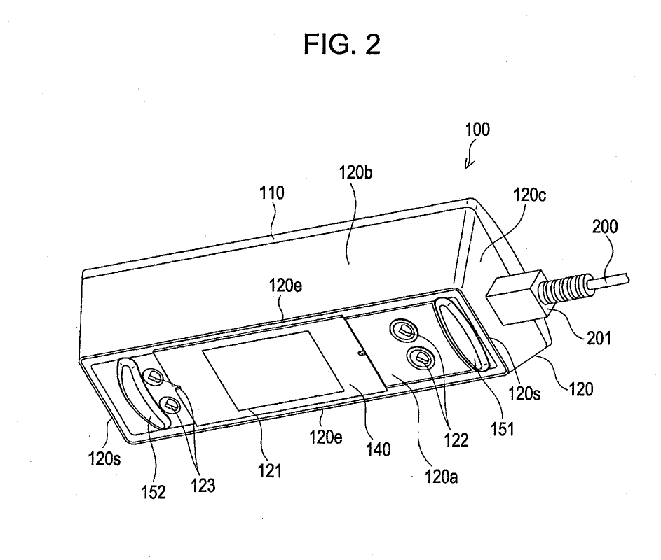

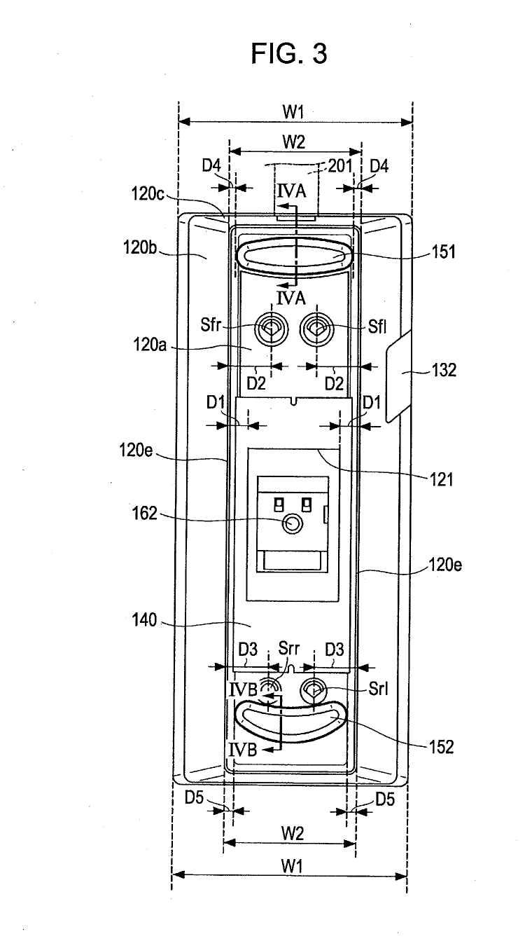

FIG. 1 is an exemplary view showing an external appearance of an upper side of the mouse scanner according to the first embodiment of the invention. FIG. 2 is an exemplary view showing an external appearance of a lower side of the mouse scanner according to the first embodiment of the invention. FIG. 3 is a view showing an arrangement configuration of a bottom portion of the mouse scanner. The mouse scanner 100 serves as a pointing device used for manipulation of a computer (not shown) as well as an image reading apparatus, which optically reads an object (a document) to be read to output image data to the computer connected through a cable 200. The mouse scanner 100 is what is called a hand scanning type scanner, and reads a document by manually scanning the object (the document) to be read while making contact with the object. As shown in FIGS. 1 and 2, the mouse scanner 100 includes the upper housing member 110, the lower housing member 120, the wheel 131, the reading button 132, the transmission plate 140, the front foot section 151 and the rear foot section 152.

The upper housing member 110 is a cover member with an external appearance of a substantially long board shape and is disposed on the upper portion of the lower housing member 120. The upper housing member 110 and the lower housing member 120 form a housing of the mouse scanner 100. The upper housing member 110 is formed substantially at the center in the short side direction thereof with a wheel opening 111, so that a part of the wheel 131 disposed in the housing is exposed through the wheel opening 111. Further, the upper housing member 110 is formed at a part of the long side thereof with a notch portion 112 in which the reading button 132 is disposed. According to the embodiment, as shown in FIG. 3, the upper housing member 110 has a width W1 in the short side direction thereof.

The lower housing member 120 has a substantially box shape with an upper opening and includes a bottom surface 120a, lateral sides 120b formed at the long side thereof, and lateral sides 120c formed at the short side thereof. The bottom surface 120a is formed at the lower portion of the lower housing member 120 and has a substantially rectangular shape. The bottom surface 120a includes a long side 120e formed in the longitudinal direction thereof and having a substantially linear shape, and a short side 120s formed in the direction (hereinafter, referred to as a transverse direction) perpendicular to the longitudinal direction and having a substantially linear shape. As shown in FIG. 3, the width W2 of the short side 120s is formed to be shorter than the width W1 in the short side direction of the upper housing member 110. Thus, the mouse scanner 100 according to the embodiment has a substantially trapezoidal sectional shape in the direction perpendicular to the longitudinal direction. The lateral sides 120b are aligned adjacent to the bottom surface 120a via the long side 120e. Further, the lateral sides 120c are aligned adjacent to the bottom surface 120a via the short side 120s of the bottom surface 120a. According to the embodiment, the short side 120s is formed in the linear shape. However, the invention is not limited thereto. For example, the short side 120s may be formed in a curved shape such as a chevron shape.

The lateral side 120c of the lower housing member 120 is formed with an opening (not shown) through which a connector 201 is connected to the lower housing member 120. Hereinafter, according to the embodiment, a side of one of the lateral sides 120c formed with the opening so as to contact with the connector 201 will be referred to as a front side of the mouse scanner 100, and a side of the other one of the lateral sides 120c will be referred to as a rear side.

In relation to the lower housing member 120, a document reading opening 121 having a rectangular shape is formed substantially in the center of the bottom surface 120a. The document reading opening 121 allows an imaging section (not shown) disposed in the housing to read the document. One pair of end sides of the document reading opening 121 is formed to be substantially parallel to the long side 120e. According to the embodiment, the distance from the end side of the document reading opening 121 to the long side 120e in the transverse direction of the bottom surface 120a is defined as D1. The document reading opening 121 corresponds to an opening in the scope of the appended claims.

The lower housing member 120 is formed with front position detection openings 122 having two small windows formed in a row along the transverse direction of the bottom surface 120a between the short side 120s formed at the front side of the bottom surface 120a and the document reading opening 121. Further, the lower housing member 120 is formed with rear position detection openings 123 having two small windows formed in a row along the transverse direction of the bottom surface 120a between the short side 120s formed at the rear side and the document reading opening 121. The front position detection openings 122 are disposed such that the distance D2 from the center of each front position detection opening 122 to the long side 120e is longer than the distance D1 from the end side of the document reading opening 121 to the long side 120e. Further, the rear position detection openings 123 are disposed such that the distance D3 from the center of each rear position detection opening 123 to the long side 120e is longer than the distance D1 from the end side of the document reading opening 121 to the long side 120e. Herein, the distance D2 may be identical to or different from the distance D3.

In relation to the lower housing member 120, the notch portion 120d is formed in a part of the lateral side 120b at the position corresponding to the notch portion 112 of the upper housing member 110. The reading button 132 is disposed in the opening formed by the notch portions of the upper housing member 110 and the lower housing member 120. When the mouse scanner 100 is used as a pointing device, the wheel 131 is used to perform scroll or selection of an image displayed on a computer. The reading button 132 is pressed when the document is read by the mouse scanner 100. The transmission plate 140 is a flat plate having a substantially rectangular shape to cover the document reading opening 121. The transmission plate 140, for example, is formed using a transparent plastic plate or a glass plate.

Each of the front foot section 151 and the rear foot section 152 is a sliding member to reduce friction between the mouse scanner 100 and the document, and is made of plastic, urethane or the like. The front foot section 151 and the rear foot section 152 have a plane with a substantially oval shape and a trapezoidal section, and are disposed on the bottom surface 120a to form a convex section on the outer surface of the bottom surface 120a. Thus, when the document is scanned by the mouse scanner 100, the front foot section 151 and the rear foot section 152 make contact with the document.

The front foot section 151 is disposed between the short side of the front side of the bottom surface 120a and the front position detection openings 122. The front foot section 151 has a shape extending along the short side 120s of the bottom surface 120a. The front foot section 151 is disposed such that the distance D4 from the end of the front foot section 151 to the long side 120e is shorter than the distance D1 from the opening end side of the document reading opening 121 to the long side 120e.

The rear foot section 152 is disposed between the short side of the rear side of the bottom surface 120a and the rear position detection openings 123. The rear foot section 152 has a shape extending along the short side 120s of the bottom surface 120a. The rear foot section 152 is disposed such that the distance D5 from the end of the rear foot section 152 to the long side 120e is shorter than the distance D1 from the opening end side of the document reading opening 121 to the long side 120e.

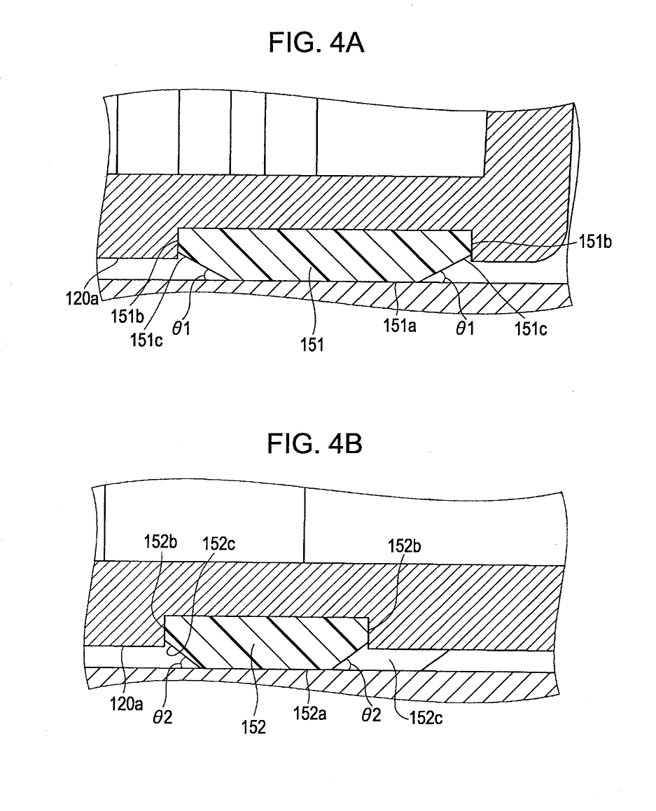

FIGS. 4A and 4B are exemplary views showing the sections of the foot sections. FIG. 4A is a sectional view taken along line IVA-IVA of FIG. 3 and FIG. 4B is a sectional view taken along line IVB-IVB of FIG. 3. As shown in FIG. 4A, the front foot section 151 includes a contact surface 151a, which makes contact with the document, a lateral side 151b, which is formed in the thickness direction, and a chamfered portion 151c formed between the contact surface 151a and the lateral side 151b. The chamfered portion 151c is configured to have an angle θ1 of 10° to 45° with respect to the document when the contact surface 151a makes contact with the document. It is preferred that the angle θ1 is about 28°.

Similarly to the front foot section 151, as shown in FIG. 4B, the rear foot section 152 includes a contact surface 152a, which makes contact with the document, a lateral side 152b, which is formed in the thickness direction, and a chamfered portion 152c formed between the contact surface 152a and the lateral side 152b. The chamfered portion 152c is configured to have an angle θ2 of 10° to 45° with respect to the document when the contact surface 152a makes contact with the document. It is preferred that the angle θ2 is about 28°.

### A2. Arrangement Configuration of Position Detection Module

The mouse scanner 100 has four position detection modules therein. The position detection modules are respectively disposed in the small windows of the front position detection openings 122 and the rear position detection openings 123 by allowing each center of the position detection modules to be aligned with each center of the small windows. The position detection module disposed in the right small window (see the left side of FIG. 3) of the front position detection openings 122 will be referred to as a right front position detection module Sfr, and the position detection module disposed in the left small window (see the right side of FIG. 3) of the front position detection openings 122 will be referred to as a left front position detection module Sfl. Further, the position detection module disposed in the right small window (see the left side of FIG. 3) of the rear position detection openings 123 will be referred to as a right rear position detection module Srr, and the position detection module disposed in the left small window (see the right side of FIG. 3) of the rear position detection openings 123 will be referred to as a left rear position detection module Srl.

The position detection modules Sfr, Sfl, Srr and Srl detect the position and direction of the mouse scanner 100 relative to a document, a mouse pad or the like. In detail, the position detection modules Sfr, Sfl, Srr and Srl detect movement amounts in the two directions perpendicular to each other. The mouse scanner 100 determines a relative position relation of an image, which has been read by functioning as the document reading apparatus, and a movement amount of a pointer as the pointing device from the detected movement amounts in the two directions. The mouse scanner 100 detects the movement amounts by using at least two of the position detection modules Sfr, Sfl, Srr and Srl, thereby calculating the rotational direction and rotation degree in addition to the movement direction and the movement amount of the mouse scanner 100.

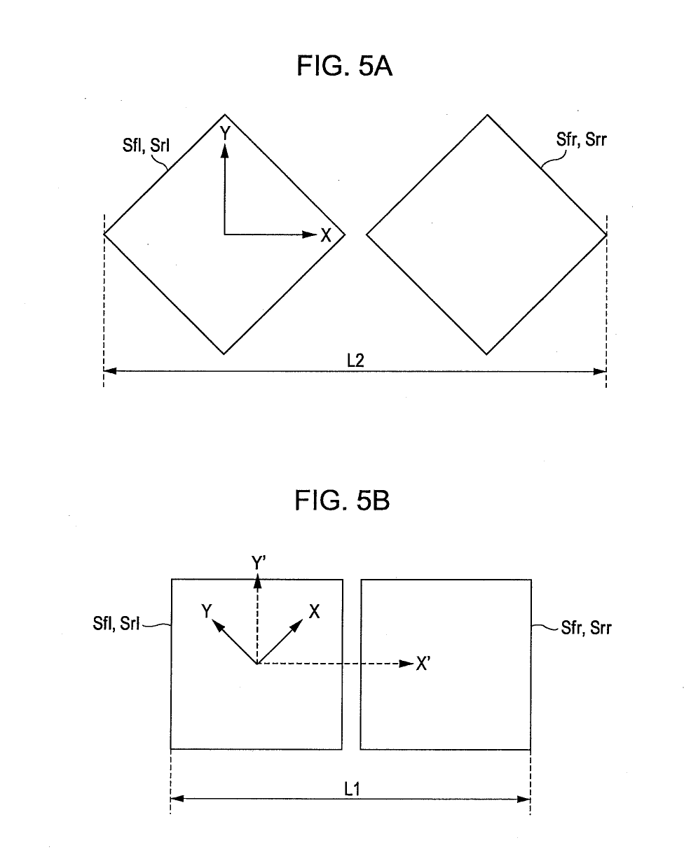

FIGS. 5A and 5B are views showing the arrangement configuration of the position detection modules in the mouse scanner. FIGS. 5A and 5B show the arrangement configuration of the front position detection modules Sfr and Sfl and the rear position detection modules SIT and Srl of the mouse scanner. Each of the position detection modules Sfr, Sfl, Srr and Srl has a substantially square surface to detect the movement amounts in the diagonal directions. In order to define the movement amount (hereinafter, referred to as a Y-direction movement amount) in one of the diagonal directions as a movement amount in the longitudinal direction of the bottom surface 120a, and the movement amount (hereinafter, referred to as an X-direction movement amount) in the other one of the diagonal directions as a movement amount in the transverse direction of the bottom surface 120a, the diagonal directions of the position detection modules Sfr, Sfl, Srr and Srl must be respectively parallel to the longitudinal and transverse directions of the bottom surface 120a as shown in FIG. 5A.

In the position detection modules Sfr, Sfl, Srr and Srl according to the embodiment, the ends of the modules are configured to be respectively parallel to the longitudinal and transverse directions of the bottom surface 120a as shown in FIG. 5B. Further, the mouse scanner 100 applying Equations (1) and (2) below to the detected Y-direction movement amount and X-direction movement amount, thereby calculating a Y′ direction movement amount, which is the movement amount in the longitudinal direction of the bottom surface 120a, and an X′ direction movement amount, which is the movement amount in the transverse direction of the bottom surface 120a.

Y′=X cos (45+e)+Y cos (45+e) 1

X′=X cos (45+e)−Y cos (45+e) 2

In Equations 1 and 2, e denotes an installation error when the position detection modules are mounted.

That is, the mouse scanner 100 dividing the detected movement amounts in the diagonal directions of the position detection modules into a longitudinal direction component of the bottom surface 120a and a transverse direction component of the bottom surface 120a, thereby calculating the movement amount in the longitudinal direction of the bottom surface 120a and the movement amount in the transverse direction of the bottom surface 120a. Thus, in the position detection modules Sfr, Sfl, Srr and Srl according to the embodiment, the width L1 in the transverse direction as shown in FIG. 5B is smaller than the width L2 in the transverse direction of the position detection modules disposed as shown in FIG. 5A.

### A3. Reading of Document by Mouse Scanner

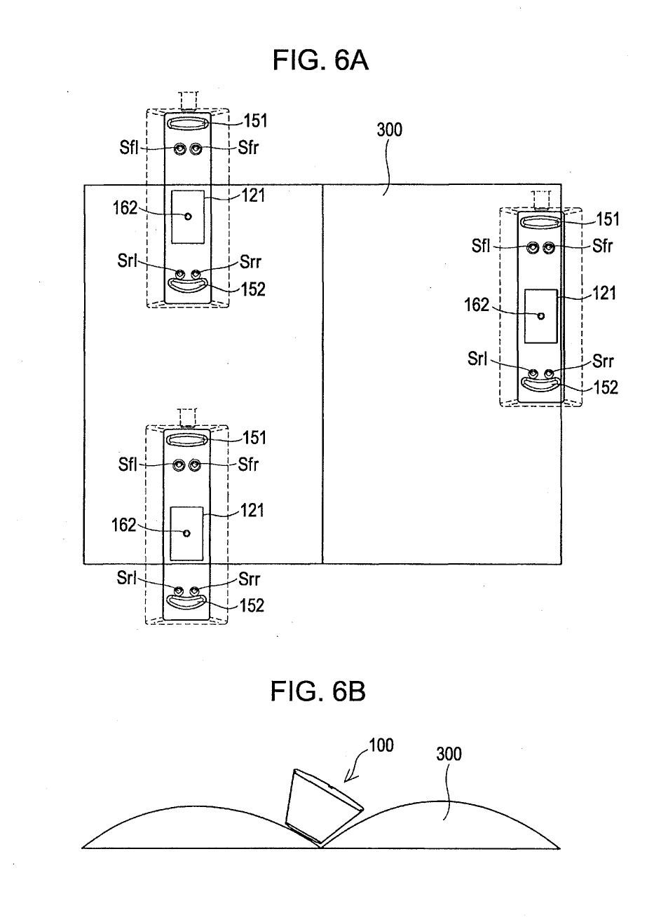

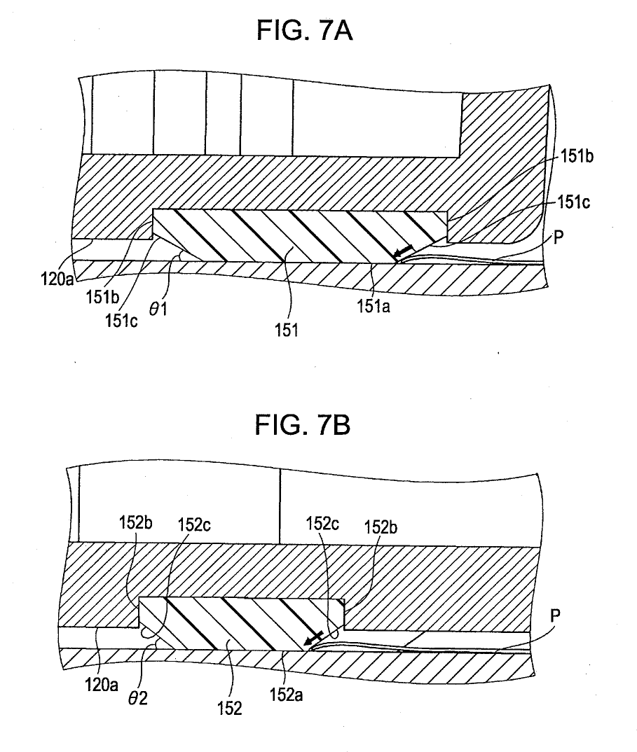

FIGS. 6A and 6B are views showing a state in which the document is read by the mouse scanner. FIGS. 7A and 7B are views showing a state of the vicinity of the foot section when the document is read. As shown in FIG. 6A, when the vicinity of the upper end of the page of the book 300 is read by the mouse scanner 100, there may occur a case in which the front position detection modules Sfr and Sfl depart from the surface of the document. However, even in such a case, the two rear position detection modules Srr and Srl remain on the surface of the document, so that the detection of the movement amount can be performed by the two position detection modules. Further, similarly to this, when the vicinity of the lower end of the page of the book 300 is read by the mouse scanner 100, there may occur a case in which the rear position detection modules Srr and Srl depart from the surface of the document. However, even in such a case, the two front position detection modules Sfr and Sfl remain on the surface of the document, so that the detection of the movement amount can be performed by the two position detection modules.

The position detection modules Sfr, Sfl, Srr and Srl are disposed at the position remote from the long side 120e, as compared with the document reading opening 121. Thus, although the end side of the document reading opening 121 overlaps the edge end portion of the document in order to read the vicinity of the end portion near the fore edge of the page of the book 300, the position detection modules Sfr, Sfl, Srr and Srl remain on the document. Consequently, even in such a case, the detection of the movement amount can be performed using the two or more position detection modules.

Further, the bottom surface 120a of the mouse scanner 100 is formed in the rectangular shape. Thus, even when reading the document having a chevron shape in the vicinity of a valley portion of a page formed at a gutter of the book 300 as shown in FIG. 6B, the width in the transverse direction is suppressed, so that reading of the document can be facilitated. In addition, since the long side 120e has the substantially linear shape, the mouse scanner 100 is allowed to crawl the valley portion of the page, so that the reading of the document can be facilitated.

As compared with the document reading opening 121, since the front foot section 151 and the rear foot section 152 are located adjacently to the long side 120e, even when reading the vicinity of the end of the document, at least a part of the contact surfaces 151a and 152a can easily remain on the document. Thus, it is possible to prevent the document from being caught when the front foot section 151 and the rear foot section 152, which have departed from the document, are placed on the document. Further, as shown in FIGS. 7A and 7B, after the front foot section 151 and the rear foot section 152 depart from the surface of the document in order to read the vicinity of the end of the document, even if the front foot section 151 and the rear foot section 152 are placed on the document again, the end of the document to be contacted is moved downward by the chamfered portions 151c and 152c when they are placed thereon, so that the front foot section 151 and the rear foot section 152 can be easily placed thereon.

According to the mouse scanner 100 of the first embodiment as described above, the position detection modules Sfr, Sfl, Srr and Srl are disposed as a pair while interposing the document reading opening 121 therebetween, so that the position of the document reading apparatus can be detected with high accuracy. In detail, when the end of the document is read, although two of the four position detection modules disposed while interposing the document reading opening 121 therebetween depart from the surface of the document, the remaining two position detection modules remain on the surface of the document, so that the detection of the movement amount can be performed by the two position detection modules.

According to the mouse scanner 100 of the first embodiment, the position detection modules Sfr, Sfl, Srr and Srl are disposed between the document reading opening 121 and the short sides 120s as a pair, so that the position of the document reading apparatus can be detected with high accuracy. In detail, when the upper end or the lower end of the document is read, although two of the four position detection modules disposed at the front side or the rear side depart from the surface of the document, the remaining two position detection modules remain on the surface of the document, so that the detection of the movement amount can be performed by the two position detection modules.

According to the mouse scanner 100 of the first embodiment, on the basis of the transverse direction of the bottom surface 120a, the distance from the bottom surface 120a to the position detection modules Sfr, Sfl, Srr and Srl is longer than the distance from the long side 120e to the document reading opening 121, so that the position of the document reading apparatus can be detected with high accuracy. In detail, as shown in FIG. 6A, when the document is read while the long side 120e is moved along the end side of the document, although the end side of the document reading opening 121 overlaps the end side of the document, the position detection modules Sfr, Sfl, Srr and Srl remain on the document, so that the detection of the movement amount can be performed by the two or more position detection modules.

According to the mouse scanner 100 of the first embodiment, the position detection modules Sfr and Sfl disposed at the front side are spaced apart from the long side 120e by the same distance D2, respectively, and the position detection modules Srr and Srl disposed at the rear side are spaced apart from the long side 120e by the same distance D3, respectively, so that the position of the document reading apparatus can be detected with high accuracy. In detail, in relation to the position detection modules Sfr and Sfl disposed at the front side and the position detection modules Srr and Srl disposed at the rear side, they are spaced apart from the long side 120e by the same distance D2 and D3, respectively, so that calculation in the rotational direction can be easily performed.

According to the mouse scanner 100 of the first embodiment, the position detection modules Sfr and Sfl disposed at the front side and the position detection modules Srr and Srl disposed at the rear side are disposed along the short side of the document reading opening 121, respectively, so that the position of the document reading apparatus can be detected with high accuracy. In detail, in relation to the bottom surface 120a, since the vicinity of the end side of the document reading opening 121 hardly departs from the surface of the document, the detection of the movement amount can be performed with high efficiency.

According to the mouse scanner 100 of the first embodiment, the position detection modules Sfr, Sfl, Srr and Srl detect the movement amount of the bottom surface 120a that has rotated by 45° with respect to the longitudinal direction, so that the document reading apparatus can read the document with high efficiency. In detail, each of the position detection modules Sfr, Sfl, Srr and Srl has the substantially square surface to detect the movement amounts in the diagonal directions. To this end, the position detection modules Sfr, Sfl, Srr and Srl are configured to detect the movement amount of the bottom surface 120a that has rotated by 45°, so that the ends of the position detection modules Sfr, Sfl, Srr and Srl are respectively parallel to the longitudinal and transverse directions of the bottom surface 120a, and the widths in the transverse direction of the position detection modules Sfr, Sfl, Srr and Srl are suppressed. Consequently, the width in the transverse direction of the bottom surface 120a can be further shortened.

### B. Modified Example

The invention is not limited to the previous embodiments. Various modifications can be made within the scope of the appended claims. For example, the following modifications can be made.

### B1. First Modified Example

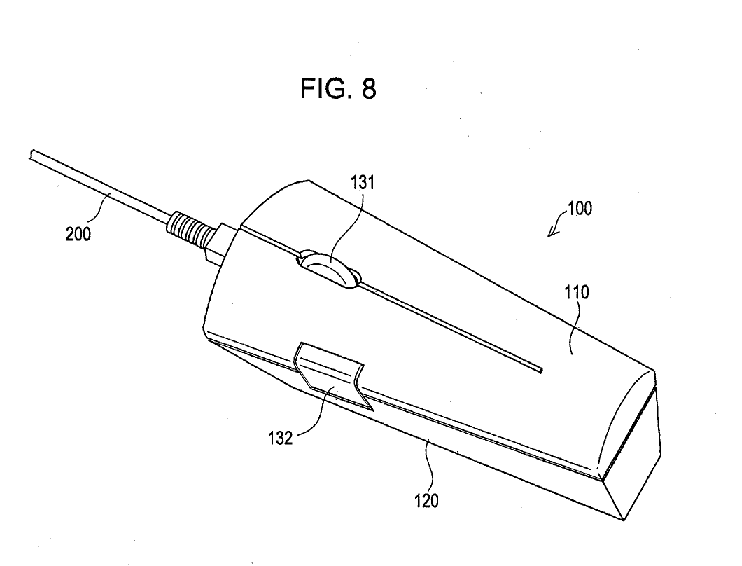

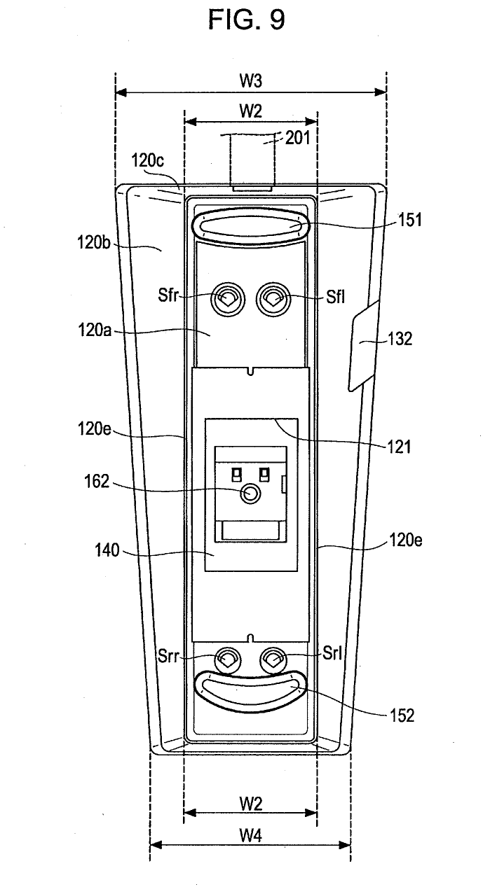

FIG. 8 is an exemplary view showing an external appearance of an upper side of a mouse scanner according to the modification. FIG. 9 is a view showing an arrangement configuration of a lower portion of the mouse scanner according to the modification. In the mouse scanner 100 according to the previous embodiment, the upper housing member 110 has the external appearance with the substantially long board shape. However, the shape of the upper housing member 110 is not limited thereto. For example, although the upper housing member 110 has a plane with a trapezoidal shape as shown in FIG. 8, the scanning efficiency of the mouse scanner 100 can be improved. In detail, as shown in FIG. 9, since the width W3 in the short side direction at the front side of the upper housing member 110 is wider than the width W4 at the rear side, it is easy to hold the mouse scanner 100 and the mouse scanner 100 can easily perform the scanning operation. Further, since the width W2 of the short side 120s is narrower than the width W3 and the width W4, so that the reading of the document can be facilitated.

Further, the shape of the housing is not limited to the shape disclosed in the previous embodiment and the first modification. For example, the housing may have a plane of an oval shape and may have a section with a chevron shape. Further, the lower housing member 120 may serve as a lower cover. In addition, the housing may have various sectional shapes other than the trapezoidal shape.

### B2. Second Modified Example

In the mouse scanner 100 according to the previous embodiment, the upper housing member is formed with the wheel opening 111 and the part of the wheel 131 is exposed. However, the wheel 131 may not be provided. Further, the reading button 132 is disposed at the lateral side of the mouse scanner 100. However, the reading button 132 may be disposed at various positions.

### B3. Third Modified Example

In the mouse scanner 100 according to the previous embodiment, the distance from the position detection modules Sfr, Sfl, Srr and Srl to the long side 120e is longer than the distance from the document reading opening 121 to the long side 120e. However, the invention is not limited thereto. For example, the distance from the position detection modules Sfr, Sfl, Srr and Srl to the long side 120e may be equal to or smaller than the distance from the document reading opening 121 to the long side 120e. Even in such a case, the position of the document reading apparatus can be detected with high accuracy.

### B4. Fourth Modified Example

In the mouse scanner 100 according to the previous embodiment, the position detection modules Sfr and Sfl disposed at the front side and the position detection modules Srr and Srl disposed at the rear side are disposed in a row along the transverse direction of the bottom surface 120a, respectively. However, the invention is not limited thereto. For example, they may be disposed in a row along the longitudinal direction of the bottom surface 120a, respectively. Even in such a case, the detection of the movement amount can be performed by the two or more position detection modules.

### B5. Fifth Modified Example

In the mouse scanner 100 according to the previous embodiment, the ends of each position detection module Sfr, Sfl, Srr or Srl are configured to be parallel to the longitudinal and transverse directions of the bottom surface 120a. However, the arrangement positions of each position detection module Sfr, Sfl, Srr or Srl may not be particularly limited. For example, the diagonal lines of each position detection module Sfr, Sfl, Srr or Srl may be configured to be parallel to the longitudinal and transverse directions of the bottom surface 120a. Further, the mouse scanner 100 according to the previous embodiment calculates the movement amount in the longitudinal direction of the bottom surface 120a and the movement amount in the transverse direction of the bottom surface 120a by applying Equations (1) and (2). However, the invention may be realized as a mouse scanner without applying Equations (1) and (2) due to difference or the like in use of the arrangement, the detection direction or the like of the position detection modules.

### B6. Sixth Modified Example

In the mouse scanner 100 according to the previous embodiment, one pair of the end sides of the document reading opening 121 are formed to be substantially parallel to the long side 120e. However, the position and shape of the document reading opening 121 are not limited thereto. For example, the document reading opening 121 may have a circular shape, and may be eccentrically located at one side of the bottom surface 120a.

### B7. Seventh Modified Example

The mouse scanner 100 according to the previous embodiment has a function as the pointing device. However, the mouse scanner 100 may be realized as a document reading apparatus having only a scanning function.

### B8. Eighth Modified Example

The invention can be realized as a copy machine, a facsimile machine or the like, which is provided at a part thereof with a hand scanner, in addition to the hand scanner and the mouse scanner.

What is claimed is:

1. A document reading apparatus comprising:
a housing including a bottom surface formed with an opening for reading a document; and
position detection sections disposed on the bottom surface as a pair while interposing the opening therebetween, thereby detecting a position of the document reading apparatus.

2. The document reading apparatus according to claim 1, wherein the bottom surface has a pair of long sides and a pair of short sides connecting both ends of each long side, and the position detection sections are disposed between the opening and the short sides.

3. The document reading apparatus according to claim 2, wherein a distance in a short side direction of the bottom surface from the long side to the position detection section is longer than a distance in the short side direction from the long side to the opening.

4. The document reading apparatus according to claim 2, wherein the two position detection sections disposed between the opening and the short side are spaced apart from the long side by an equal distance in a short side direction, respectively.

5. The document reading apparatus according to claim 4, wherein the opening has a rectangular shape, and the two position detection sections are disposed along end sides of the opening, respectively.

6. The document reading apparatus according to claim 1, wherein the position detection sections detect a movement amount in a direction rotated by 45° with respect to a long side direction of the bottom surface.
